(19) United States
(12) Patent Application Publication
(10) Pub. No.: US 2002/0091946 A1
(43) Pub. Date: Jul. 11, 2002

(54) Method and apparatus for activating a computer after user authentication by a password, program, and program storage medium therefor

(75) Inventor: Masahiko Satoh, Yamagata (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/023,499

(22) Filed: Dec. 17, 2001

(30) Foreign Application Priority Data
Dec. 15, 2000 (JP) 381759/2000

(51) Int. Cl. G06F 12/14

(52) U.S. Cl. 713/202

(57) ABSTRACT

An input password entered from a keyboard is compared and collated with a registered password in a provisional state before power supply is started to main body operation units. In operation, each of the input and the registered passwords may include characters, numerals and marks entered through input operations on a keyboard 3. A keyboard/power supply controller 4 compares and checks an input password from the keyboard 3 with the password registered in the memory 9. If both match with each other, the keyboard/power supply controller 4 controls a DC/DC converter 6 to start the supply of power to the main body operation units (LCD 7, CPU 8, memory 9) Otherwise, the keyboard/power supply controller 4 controls a DC/DC converter 6 to suspend the supply of power to the main body operation units.

### BACKGROUND OF THE INVENTION

1. Field of the Invention

The present invention relates to a method, an apparatus, and a program storage medium, for activating a computer after user authentication by the use of a password. In particular, the present invention relates to the method, the apparatus, and the program storage medium which can be effectively used in a battery-operated computer like a notebook personal computer (hereinbelow abbreviated to a notebook PC),such that an input password is compared and checked with a registered password and, as a result, power supply is executed for main body operation units, including a display, a central processing unit and a memory, after the authentication of the user.

2. Description of the Related Art

Upon booting up a conventional computer, such as a notebook PC, a password (personal identification number or code) should be often input to identity the password as a registered user's one so as to prevent the computer from being used by any other person than an authenticated person. This password identification process, however, is performed in such a condition that power is supplied to the main body operation units of the notebook PC. In other words, in the case of a battery-operated notebook PC, battery life will be wasted in the password identification process. Therefore, if an unauthenticated person or foe who does not know a registered password has turned the notebook PC on many times to repeat trial entries of the password, it will require a large amount of power consumption, which may make the battery go dead.

In many cases, such a password identification process is performed on a notebook PC by starting the supply of power to the main body operation units to start control operation of the CPU so as to launch a program for an input/output apparatus interface (such as BIOS (Basic Input/Output System) or an operating system (OS). Therefore, the battery-operated notebook PC is required to consume a large amount of battery power.

So far proposals have been made about accomplishing power savings and keeping secrecy of stored information security by using a password recognition technique. For example, such proposals have been made in Japanese patent unexamined publication Nos. Hei 11-102240 and 2000-105622. Those conventional approaches are to control the start of the main power supply to a computer system (main body operation units) on the basis of the validity (verification) of the password input.

More specifically, the former makes it possible to start the main power supply to the main body operation units In response to an input operation of a valid password. In this case, however, judgment of the password is made by operation times of a switch that is turned on and off. This shows that tho password is limited to numerals or input times. Consequently, the degree of difficulty in verifying a password remains insecure.

In the latter, a password fetch control system (keyboard/security control apparatus) is given power before the start of energization of the main body operation units, which still leaves room for improvement.

### SUMMARY OF THE INVENTION

It is an object of the present invention to solve the above-mentioned conventional problems and provide a method, an apparatus, a program storage medium, and a program for activating a computer as a result of user authentication through a password, which meets the following requirements (1), (2) and (3).

(1) When using a battery-operated computer, a password of coded symbols from a keyboard is put into a comparable state with a registered password before the start of the power supply to main body operation units. Consequently, even for a password consisting of numerals only, the degree of difficulty in verifying the password can be improved, thereby preventing fraud securely.

(2) When using a battery-operated computer, the supply of power to main body operation units is started only when the validity of a password highly is high confirmed in difficulty level of verification. This makes it possible to achieve considerable power saving.

(3) The requirement (1) for improving the degree of difficulty in verifying a password and the requirement (2) for achieving considerable power saving are accomplished by using only the devices constituting the notebook PC without the need for special equipment or devices (such as circuits).

In attaining the above-mentioned object and according to the present invention, there is provided a method of activating a computer as a result of authentication through a password, in which power is supplied as a result of the authentication performed by comparing and checking an input password with a registered password. The method comprises the steps of: registering a password consisting of symbols including characters, numerals and marks through input operations; controlling the computer to maintain a state before the start of the supply of power to main body operation units in the computer; performing user authentication by comparing and checking a password entered through later input operations with the registered password; and starting the supply of power to the main body operation units when the input password matches the registered password, while the supply of power is put into a suspended state to the main body operation units when the input password does not match the registered password.

The method according to the present invention features that the password is compared and checked within a predetermined, fixed period of time.

The method according to the present invention also features that when the password consists of more than one-digit symbol, the input password is compared and checked with the registered password on a digit basis.

According to the present invention, there is also provided a computer apparatus for supplying power to main body operation units as a result of authentication performed by comparing and checking an input password with a registered password. The apparatus comprises; input operation means for registering a password consisting of symbols including characters, numerals and marks through input operations; storage means for storing the password registered through the input operation means; direct-current supplying means for supplying power to the main body operation units in the computer; and control means for controlling the direct-current supplying means to start supplying power to the main body operation units when the password input from the input operation means matches the password registered in the storage means, while controlling the DC supplying means to suspend supplying power to the main body operation units when the input password does not match the registered password.

The apparatus according to the present invention is such that the control means controls the DC supplying means to start or suspend supplying power to the main body operation units including a display, a central processing unit and a memory.

The apparatus according to the present invention is also such that the DC supplying means includes an AC-DC converting power supply for conversion of DC from AC, a battery and a DC stabilizing circuit, whereby the control means controls the DC stabilizing circuit to supply DC to the main body operation units.

According to the present invention, there is further provided a program storage medium storing thereon a program executed by a computer. The program comprises the processing steps of: registering a password consisting of symbols including characters, numerals and marks through input operations, controlling the computer to maintain a state before the start of the supply of power to main body operation units in the computer; performing user authentication by comparing and checking a password entered through later input operations with the registered password; and starting the supply of power to the main body operation units when the input password matches the registered password, while suspending the supply of power to the main body operation units when the input password does not match the registered password.

The program storage medium according to the present invention stores a program for letting the computer further execute a processing step of comparing and checking the passwords within a fixed period of time, and a processing step of comparing and checking the passwords on a digit basis when each password consists of more than one-digit symbol.

According to the present invention, authentication is performed by comparing and checking a password consisting of symbols (characters, numerals and marks) entered from a keyboard or the like before the start of the power supply to the main body operation units, with passwords registered beforehand. This makes it possible to improve the degree of difficulty in verifying the password compared to the verification of a password consisting of numerals only, and hence to prevent fraud securely.

Further, according to the present invention, when using a battery-operated computer such as a notebook PC, the power supply to the main body operation units is started only when a password high in difficulty level of verification is confirmed before the start of the power supply to the main body operation units. This makes it possible to achieve greater power savings.

Furthermore, according to the present invention, the improvement of the degree of difficulty in verifying a password and the achievement of greater power savings are carried out without the need for special equipment or devices (such as circuits). In other words, verification of a password high in difficulty level of verification is made possible by using only the devices constituting the notebook PC.

### BRIEF DESCRIPTION OF THE DRAWINGS

FIG. 1 is a block diagram showing structure of an embodiment according to the present invention; and

FIG. 2 is a flowchart for explaining processing procedures in the embodiment.

### DESCRIPTION OF THE PREFERRED EMBODIMENTS

Referring now to the accompanying drawings, description will be made about an embodiment of a method, an apparatus, a program storage medium, and a program for activating a computer as a result of authentication through a password.

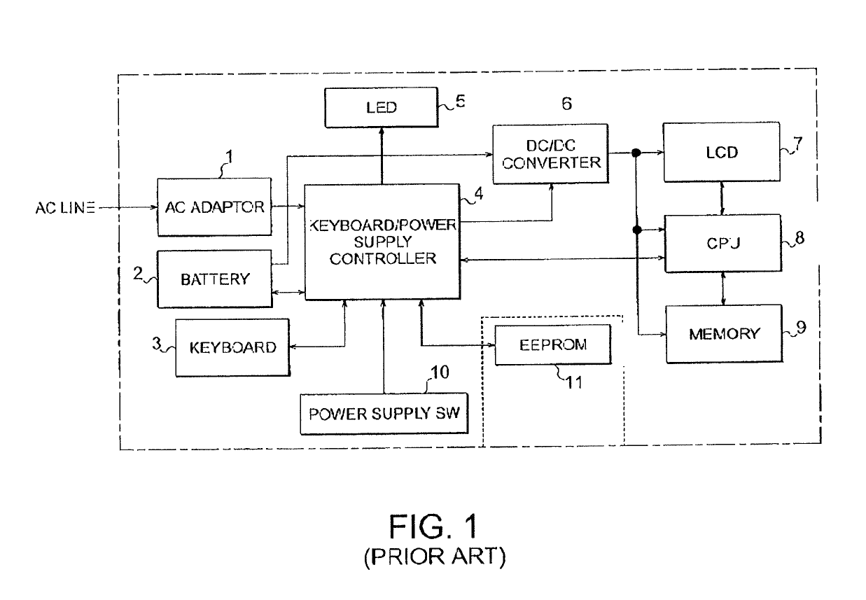

FIG. 1 is a block diagram showing tho structure of tho embodiment that realizes a method, an apparatus, and a program storage medium, for activating a computer as a result of authentication through a password.

It is assumed in FIG. 1 that the computer is a notebook PC as a specific example of a compact general-purpose computer in which a battery is incorporated. The notebook PC is provided with an AC adopter 1 as DC supplying means and an AC-DC converting power supply, and a battery 2 as the DC supplying means. The AC adopter 1 outputs a charging DC voltage from a commercial AC power supply to apply the charging voltage to the battery 2. The notebook PC is also provided with a keyboard 3 as input operation unit and a keyboard/power supply controller 4. The keyboard 3 allows an operator or user to perform therefrom not only various input operations, but also input operations of symbols (characters, numerals and marks) for use in verifying a password before the start of the power supply. The keyboard/power supply controller 4 is operated in accordance with firmware (F/W) as a control unit or means.

The notebook PC is further provided with a light-emitting diode (LED) 5 and a DC/DC converter 6 as the DC supplying means The LED 5 is turned on to indicate various operating states such as keyboard connection, such a state that the power supply is turned on or off, a battery's state of charge and a memory's state of activation. The DC/DC converter 6 delivers a stabilized DC voltage to various parts of the notebook PC. Furthermore, the notebook PC is provided with a liquid crystal display (LCD) 7, a CPU 8 and a memory 9. The LCD 7 displays various data and their processed states on its screen. The CPU 8 controls each unit of the notebook PC; it includes a ROM storing a bootstrap and a control program, a working RAM and an input/output (I/O) circuit. The memory 9 as storage means is to store processed data.

In addition, the notebook PC is provided with a power-supply switch (SW) 10 and an EEPROM 11 as storage means. The EEPROM 11 is preset to store and hold a rewritable password or passwords.

The notebook PC of this type normally incorporates therein a hard disk (HD) drive and/or a floppy disk (FD) drive, but such a built-in drive is not shown in FIG. 1.

Next, description will be made about the operation of the embodiment.

First, the operation of the main parts In The structure of FIG. 1 will be described

The keyboard/power supply controller 4 controls detection of a key code from the keyboard 3, the supply of power to tho system and the battery. Upon fetching a command indicative of pressing of the power supply SW 10, the keyboard/power supply controller 4 controls the DC/DC converter 6. The DC/DC converter 6 under control starts supplying power to the CPU 8, the LCD 7 and the memory 9 as the main body operation units to get the system up and run.

In such a condition that the system is running, the keyboard/power supply controller 4 detects key input information (symbols) from the keyboard 3 to send the same to the CPU 8. The keyboard/power supply controller 4 also detects DC voltage to monitor a connected state of the AC adapter 1 with the main body operation units. In this case, if the AC adopter 1 is connected, the keyboard/power supply controller 4 controls charging of the battery 2, display of a power-on state (ON/Warning/Lowbatt), and display of an LED-on state to indicate a battery's state of charge.

In other words, the keyboard/power supply controller 4 controls the LED 5 to switch the light on or off between states of charge (charge completion and charge incompletion). The keyboard/power supply controller 4 also controls the LED 5 to indicate a state of pressing, for example, of a special key (CAPS/NUM/Scroll) on the keyboard 3.

It should be noted that a password is entered from the keyboard 3 by an administrator (mainly a user) of the notebook PC, and registered in the EEPROM 11. In this case, after getting the system up and running, the keyboard/power supply controller 4 executes writing operation of information related to the password entered from the keyboard 3, into the EEPROM 11. In other words, input password information is written from the keyboard 3 into the EEPROM 11 under control of the keyboard/power supply controller 4.

During the above-mentioned control operations of the respective units, the keyboard/power supply controller 4 does not control the DC/DC converter 6 immediately after fetching power-on information indicative of pressing the power supply SW 10. In other words, power is not supplied to the CPU 8, the LCD 7 and the memory 9 until the keyboard/power supply controller 4 reads password information from the EEPROM 11 and fetches key input information indicative of a password entered from the keyboard 3.

After reading the password information from the EEPROM 11, the keyboard/power supply controller 4 collates or checks the readout password information with the input information (characters, numerals and marks) entered from the keyboard 3.

Upon recognizing coincidence between them in the above password verification, the keyboard/power supply controller 4 controls the DC/DC converter 6 to start power supply to the CPU 8, the LCD 7 and the memory 9 so as to get the system up and to run. On the other hand, if both do not coincide or match with each other in the password verification, the keyboard/power supply controller 4 does not control the DC/DC converter 6. Therefore, the DC/DC converter 6 does not start power supply to the CPU 8, the LCD 7 and the memory. This means that the system is kept in an inactive state. Thereafter, the keyboard/power supply controller 4 finishes its control operations.

When a notebook PC is used which is operated by the battery 2 as its power supply source, the above-mentioned control operations make it possible to verify the password before the power is started to be supplied to the CPU 8, the LCD 7 and the memory 9 as the main body operation units. In other words, the key input Information concerned with the password may be formed by symbols, such as characters, numerals and marks, entered from the keyboard 3 and can be compared and checked with the password registered in the EEPROM 11 beforehand. This is effective to improve the degree of difficulty in verifying the password. For example, the password can be verified to prevent fraud securely without restricting password verification to numerals only.

Especially, as regards The notebook PC having the battery 2 as its power supply source, the power supply is started only when the password is secured at a high degree of verification before the start of the power supply to the CPU 8, LCD 7 and the memory 9. This achieves great power savings for the notebook PC using the battery 2.

The improvement of the degree of difficulty in verifying the password and the achievement of great power savings can be accomplished by only the devices constituting the notebook PC. In other words, the password which is high in difficulty of verification can be verified by using only the general-purpose devices. In this case, the general-purpose devices include the AC adapter 1, the battery 2, the keyboard 3, the keyboard/power supply controller 4, the LED 5, tho DC/DC converter 6, the power supply switch 10 and the EEPROM 11.

Next, details of the operation of the embodiment will be described.

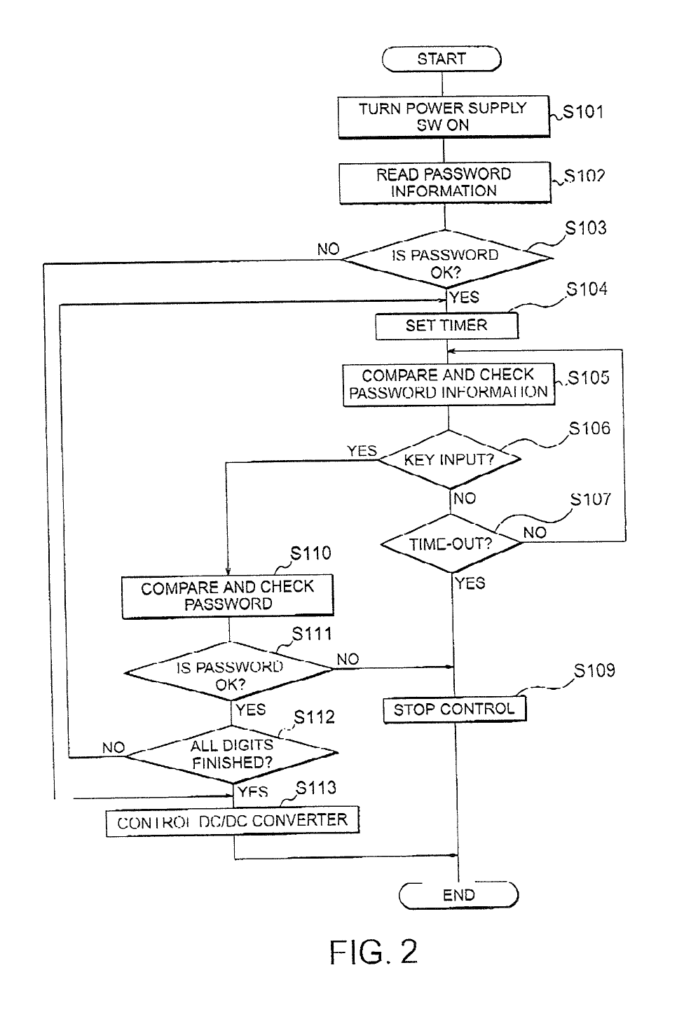

FIG. 2 is a flowchart for explaining processing procedures step by step.

As shown in FIGS. 1 and 2, the keyboard/power supply controller 4 fetches the information indicative of pressing of the power supply SW 10 to control power-on. For the control of power-on, the keyboard/power supply controller 4 starts operating in response to power supplied by pressing the power supply SW 10 (step S101). The keyboard/power supply controller 4 then reads a registered password from the EEPROM 11 (step S102). However, it is to be noted that the keyboard/power supply controller 4 does not start power supply to all the operation units in the computer but keeps them in a provisional state wherein power is not supplied to all the operational units.

Under the circumstances, the keyboard/power supply controller 4 checks or collates the input password with the password read from the EEPROM 11 (step S103). It should be noted that when no password is registered, the keyboard/power supply controller 4 controls the DC/DC converter 6 to activate and run the system without performing password verification.

This operation is efficient for the first boot-up of the notebook PC, for example, after purchase the notebook PC. At this time, since no password is registered yet, the system needs to be booted up without performing password verification. Then a password is registered. After the password is registered, a password entered as an input password from the keyboard 3 is compared and checked with the password registered before the start of the power supply, thereby preventing fraud.

When reading the password from the EEPROM 11, the keyboard/power supply controller 4 sets a value for a timer to judge the password entered from the keyboard 3 (step S104) The timer monitors or measures the time (count) until completion of fetching operation of key input information from the keyboard 3. To this end, a predetermined duration is set in tho timer in the form of a count value in consideration of the number of digits of the password information. The keyboard/power supply controller 4 then monitors the input password information given by input operations from the keyboard 3 (step S105). If no input password information is given within the set time (step S106), the keyboard/power supply controller 4 determines that a timeout occurs, namely, the predetermined time lapses(step S107).

If no timeout occurs (No in step S107), the keyboard/power supply controller 4 returns to step S105 to perform the fetching of key input information until time-out (step S105). If no key input information is fetched even upon time-out, the keyboard/power supply controller 4 determines that the password input is unauthorized and ends the control operation of the power supply.

If operated by the battery, the keyboard/power supply controller 4 is shut down to stop the power supply thereto so as to end its control operations (step S109). On the other hand, when key input information is given from the keyboard (Yes in step S106), the keyboard/power supply controller 4 compares and checks the password of the key input information with the password read from the EEPROM 11 (step S110).

Herein, it is assumed that both are not matched with each other in this verification step (No in step S111), This means that incoincidence is detected between the input password and the registered password. In this event, the keyboard/power supply controller 4 determines that the password input is unauthorized and stops controlling the DC/DC converter 6 (step S109). At this time, the power supply to the keyboard/power supply controller 4 may also be stopped to end all the control operations. From this fact, it is readily understood that user authentication is performed in a provisional state wherein the power supply is not started to all of the operation units in the notebook PC.

If both passwords are matched with each other in this verification step (step S111), the keyboard/power supply controller 4 checks the number of digits of the key input information on the password (step S112). In the embodiment, the number of digits of the key input information on the password is set to four arranged from a first digit to a fourth digit. If the key input information on the password is not placed at a fourth digit (No in step S112), the key input information is fetched. Then the keyboard/power supply controller 4 returns to step S104 of waiting for the next key input information. After that, the keyboard/power supply controller 4 monitors the key input information indicative of a key code to compare and check another digit information of the input password with the corresponding digit information on the password read from the EEPROM 11. In other words, the keyboard/power supply controller 4 repeats the comparison and check processing up to the fourth digit.

If all the four-digit symbols of the password match the corresponding ones of the password read from the EEPROM 11 (Yes in step S112), that is, when the password is valid, the keyboard/power supply controller 4 authenticates and identifies the person who has input the password. Then the keyboard/power supply controller 4 controls the DC/DC converter 6 to supply power to the CPU 8, the LCD 7 and the memory 9 so as to boot up the notebook PC (step S113).

The following describes other embodiments or modifications. In the above-mentioned embodiment, the EEPROM 11 was used as a memory for storing a password or passwords, but other types of nonvolatile memories can be used to perform the above-mentioned control operations.

Further, the keyboard/power supply controller 4 was described as being configured by a one-chip microcomputer, but the one-chip microcomputer may also incorporate therein a flash memory for registering (storing) a password or passwords, which can eliminate the need to provide a separate memory like the EEPROM 11.

Furthermore, in the above-mentioned embodiment, the number of digits of the password was four, but the number of digits can be varied. For example, if the operating environment is vulnerable to password fraud or illegal use by any other person, the number of digits can be so increased that the degree of difficulty in verifying a password will be improved. On the other hand, if the operating environment Is protected from password fraud or illegal use by any other person, the number of digits may be reduced, which makes it easy to input a password at the time of boot-up. Furthermore, such a state that a password is in comparing and checking may be audibly informed to the user or displayed on a screen during input operations of key input information corresponding to the password from the keyboard 3. For example, the keyboard/power supply controller 4 may controls The LED 5 to flash light in variable colors or light in one color during fetching of key input information corresponding to the password, so that the user is informed that the password is in comparing and checking.

In the above mentioned embodiment, if the user has forgotten the password, the user will not be able to get the system up and run. As an insurance against such a case, special two or more keys may be predetermined on the keyboard 3. In other words, the user can press the special keys so that the keyboard/power supply controller 4 will omit password verification and controls the DC/DC converter 6 to supply power so as to get the system up and run. After that, the user can set a password again while the system is running, which makes the control operations effective through password verification.

As described above and according to the present invention, the method and apparatus, and the program storage medium, for activating a computer as a result of authentication through a password are so configured that a password consisting of symbols entered from a keyboard or the like is compared with a password or passwords registered beforehand. Thus, user authentication is performed before the start of the power supply to the main body operation units. In other words, the user authentication is performed in a provisional state in the present invention.

The above-mentioned feature of the present invention makes it possible to improve the degree of difficulty in verifying a password, and hence to prevent fraud securely.

Further, according to the present invention, when using a battery operated computer, the supply of power to the main body operation units is started only when a password high in difficulty level of verification is confirmed before the start of the power supply to the main body operation units. This makes it possible to achieve greater power savings.

Furthermore, according to the present invention, no special equipment or device is required. In other words, verification of a password high in difficulty level of verification is made possible by using only the devices constituting the computer.

What is claimed is:

1. A method of activating a computer by supplying power to put the computer into an active state, comprising the steps of:
registering a password as a registered password, keeping the computer into a provisional state before the power is supplied to main body operation units in the computer;
performing user authentication in the provisional state by comparing and checking an input password with the registered password; and
starting the supply of power to the main body operation units on detecting coincidence between the input password and the registered password.

2. The method according to claim 1, further comprising the step of:
suspending the supply of power to the main body operation units on detecting incoincidence between the input password and the registered password.

3. The method according to claim 1, wherein the password is compared and checked within a predetermined period of time.

4. The method according to claim 1, wherein when the password consists of more than one-digit symbol, the input password is compared and checked with the registered password digit by digit.

5. A computer apparatus for supplying power to main body operation units as a result of authentication performed by comparing and checking an input password with a registered password, comprising;
storage means for storing the registered password;
power supplying means for supplying power to the main body operation units in the computer; and
control means for controlling said power supplying means to start power supply to the main body operation units when the input password input is matched with the registered password, and controlling said power supplying means to suspend power supply to the main body operation units when the Input password is not matched with the registered password.

6. The apparatus according to claim 5, wherein said control means controls said power supplying means to start or suspend power supply to the main body operation units including a display, a central processing unit and a memory.

7. The apparatus according to claim 5, wherein said power supplying means includes an AC-DC converting power supply for conversion of DC from AC, a battery and a DC stabilizing circuit, whereby said control means controls said DC stabilizing circuit to supply DC power to the main body operation units.

8. A program storage medium storing thereon a program executed by a computer, the program comprising the processing steps of:
registering a password as a registered password; keeping the computer into a provisional state before the power is supplied to main body operation units in the computer;
performing user authentication in the provisional state by comparing and checking an input password with the registered password; and
starting the supply of power to the main body operation units on detecting coincidence between the input password and the registered password.

9. The program storage medium according to claim 8, further comprising the step of:
suspending the supply of power to the main body operation units on detecting incoincidence between the input password and the registered password.

10. The program storage medium according to claim 8, wherein said program storage medium stores a program for letting the computer further execute a processing step of comparing and checking the passwords within a fixed period of time, and a processing step of comparing and checking the passwords on a digit basis when each password consists of more than one-digit symbol.

11. A program for use in being executed by a computer, the program comprising the steps of:
registering a password as a registered password;
keeping the computer into a provisional state before the power is supplied to main body operation units in the computer;
performing user authentication in the provisional state by comparing and checking an input password with the registered password; and
starting the supply of power to the main body operation units by changing the provisional state on detecting coincidence between the input password and The registered password.

12. The program storage medium according to claim 11, further comprising the step of:
suspending the supply of power to the main body operation units on detecting incoincidence between the input password and the registered password.

13. A computer apparatus for supplying power to main body operation units as a result of authentication performed by comparing and checking an input password with a registered password, comprising:
storage means for storing the registered password;
power supplying means for supplying power to the main body operation units in the computer; and
control means for controlling said power supplying means to put the power supplying means Into a provisional state in which the power is not supplied to all the main body operation units in the computer before the authentication is performed.

14. The computer apparatus according to claim 13, wherein the control means executes the authentication in the provisional state.
